(19) United States
(12) Patent Application Publication
(10) Pub. No.: US 2025/0292981 A1
(43) Pub. Date: Sep. 18, 2025

(54) PYROTECHNIC CIRCUIT INTERRUPTER FOR ELECTRIC VEHICLE SYSTEMS

(71) Applicant: Tesla, Inc., Austin, TX (US)

(72) Inventors: Nathaniel Hall-Snyder, Redwood City, CA (US); Pavel Dutov, Mountain View, CA (US); Jeffrey G. Reichbach, Belmont, CA (US)

(21) Appl. No.: 18/858,934

(22) PCT Filed: Apr. 25, 2023
(86) PCT No.: PCT/US2023/019830

§ 371 Date: Oct. 22, 2024

Related U.S. Application Data
(60) Provisional application No. 63/363,701, filed on Apr. 27, 2022.

(51) Int. Cl. H01H 39/00; H01H 9/34

(52) U.S. Cl. CPC H01H 39/006; H01H 9/346; H01H 2231/026

(57) ABSTRACT

A circuit interrupter may include a plurality of mounting components comprised of an insulating material for receiving a first busbar and a second busbar component. A circuit interrupter may include an arc chamber for providing a primary arc path for a current between the first and second busbar components. A circuit interrupter may include a pyrotechnic charge and pusher component located in between the first and second busbar components and the arc chamber. The pusher component may be comprised of an insulating material and can be triggered upon detection of a fault to direct ionized particles or resulting gases toward the arc chamber.

### CROSS-REFERENCE TO RELATED APPLICATION

This application claims the benefit of U.S. Provisional Application No. 63/363,701, entitled “PYROTECHNIC CIRCUIT INTERRUPTER FOR ELECTRIC VEHICLE SYSTEMS”, and filed on Apr. 27, 2022, which is hereby incorporated by reference in its entirety.

### BACKGROUND

### Technical Field

The disclosed technology relates to electric vehicle power distribution.

### Description of Related Technology

Electric vehicles and associated infrastructure can utilize conductive cable systems for conducting electricity. These cable systems can provide high current carrying capacity at the voltages required by electric vehicles and charging systems. These cables are typically flexible and contain conductive metal, encapsulated by single or multiple layers of insulation and metal sleeving for touch safety and electromagnetic compatibility (EMC) shielding.

In some scenarios, the cable systems or electrical systems may experience issues related to undesired currents or fault currents experienced in the cable systems. For example, failures in one or more components, such as a motor controller, may create undesired current or fault currents. In other example, deformation of components caused by vehicle collision may cause sudden and hazardous fault currents. In still other examples, failures in charging components or systems may also result in undesirable currents.

To prevent damage to the electric systems, electrical components, or the cable systems, the cable system can incorporate some form of circuit interrupter component or device that can be triggered in the event of a detected fault. Illustratively, the circuit interrupter types can include fuse-based components that are configured primarily as single use devices that are configured to interrupt current flow. Fuse-based devices are generally inexpensive components that primarily are intended for a single use. Another circuit interrupter type corresponds to circuit-breaker-based components that are configured primarily as multi-use devices. Circuit-breaker-based components are typically more expensive, complex devices.

### BRIEF DESCRIPTION OF THE DRAWINGS

These and other features, aspects and advantages of the present invention are described herein with reference to drawings of preferred embodiments, which are intended to illustrate, and not to limit, the present invention.

FIG. 1 is a view of an embodiment of a pyrotechnic circuit interrupter in accordance with one or more aspects of the present application.

FIG. 2A is a cross-sectional side view of an embodiment of a pyrotechnic circuit interrupter in accordance with one or more aspects of the present application.

FIG. 2B is a cross-sectional side view of an embodiment of a pyrotechnic circuit interrupter in accordance with one or more aspects of the present application.

FIG. 2C is a cross-sectional side view of an embodiment of a pyrotechnic circuit interrupter in accordance with one or more aspects of the present application.

FIG. 2D is a cross-sectional angle perspective of an embodiment of a pyrotechnic circuit interrupter in accordance with one or more aspects of the present application.

FIG. 2E is a cross-sectional angle perspective of an embodiment of a pyrotechnic circuit interrupter in accordance with one or more aspects of the present application.

FIG. 3A is a cross-sectional side view of a portion of a pyrotechnic circuit interrupter in accordance with one or more aspects of the present application.

FIG. 3B is a top view of a portion of a pyrotechnic circuit interrupter in accordance with one or more aspects of the present application.

FIG. 4 is a side view of a pyrotechnic circuit interrupter in accordance with one or more aspects of the present application.

### DETAILED DESCRIPTION

The following detailed description of certain embodiments presents various descriptions of specific embodiments. However, the innovations described herein can be embodied in a multitude of different ways, for example, as defined and covered by the claims. This description makes reference to the drawings where reference numerals can indicate identical or functionally similar elements. It will be understood that elements illustrated in the figures are not necessarily drawn to scale. Moreover, it will be understood that certain embodiments can include more elements than illustrated in a drawing and/or a subset of the illustrated elements. Further, some embodiments can incorporate any suitable combination of features from two or more drawings.

Generally described, one or more aspects of the present application correspond to a circuit interrupter. Illustratively, the circuit interrupter may include pyrotechnic charges that can be triggered during a fault. The circuit interrupter may include a plurality of mounting components for receiving a first busbar and a second busbar component. The plurality of mounting components are comprised of an insulating material. The circuit interrupter may include an arc chamber for providing a primary arc path for a current between the first and second busbar components. A circuit interrupter may include a pyrotechnic charge and pusher component located in between the first and second busbar components and the arc chamber. The pusher component can be triggered upon detection of a fault to direct ionized particles or resulting gases toward the arc.

In some embodiments, such as embodiments related to electric vehicles and electric vehicle charging systems, the electrical systems can experience voltages in the range of 450V to 1000V, or possibly higher. Such voltages are generally considered to be “higher voltage” applications and are often required in order to achieve the power demands associated with high-rate electric vehicle charging. In the event of a fault or other detected event, the vehicle and/or charging cable system can incorporate one or more circuit interrupter components that can be triggered to avoid damage to the vehicle, external charging systems, human participants, etc. As discussed above, circuit interrupter components can traditionally include fuse-based components or circuit-breaker-based components.

Circuit interrupters generally operate by creating an open circuit between two ends of a cable system, such as a busbar, in order to prevent the flow of current between the ends. The open circuit may be physically formed using some form of pyrotechnic charge that creates the open circuit in a relatively short period of time. At higher voltage levels, however, the creation of the open circuit can create scenarios in which arcing takes place between the two ends of the cable system. Additionally, depending on the configuration of the circuit interrupter, creation of the open circuit (e.g., fracturing of the busbar) may generate metal gas within physical proximity of the open circuit. In combination, the presence of metal gas or other ionized particles and arc can lead to the arc restriking or back commutation. Generally described, arc restriking or back commutation corresponds to undesirable conditions in which an alternative current path can form internal to the circuit interrupter to reduce the effectiveness of the circuit interrupter. Such reduction in effectiveness can cause direct or indirect damage to the electrical components, charging components, or individuals.

To address, at least in part, the described deficiencies in the circuit interrupters, embodiments of this disclosure relate to a pyrotechnic circuit interrupter component for utilization in electric vehicle charging systems. Illustratively, aspects of the present application relate to pyrotechnic circuit interrupters for utilization in electric busbar cable systems utilized in electric vehicle systems. The pyrotechnic circuit interrupter includes an arc chamber that is intended to direct current flow between the ends of the cable systems during an interruption event. When the device is activated while current is flowing, the arc chamber contains or otherwise directs arcing plasma created when current flow is interrupted between two ends of the cable systems (e.g., two ends of a busbar). Additionally, a combination of pyrotechnic charge and pusher element can be activated at the time of fault to generate a resulting shockwave that directs any gases formed away from the point of the open circuit. This mitigates the potential for potential arc restrikes.

Still further, other aspects of the pyrotechnic circuit interrupter can further be constructed of insulating materials, such as plastic insulators, to prevent secondary arc paths from forming. More specifically, in one embodiment, the components of the arc chamber portion of the pyrotechnic circuit interrupter can be configured such that three sides of the arc chamber are constructed primarily of insulating materials, such as insulating plastics. By limiting the conductive material of the are chamber along the desired arc path, the pyrotechnic circuit interrupter of the present application avoids arc restrikes or back communication that may have otherwise formed with the arc chamber.

In still other aspects, the arc chamber of the pyrotechnic circuit interrupter can illustratively include interlocking or interdigitated insulating plates or fins that separates out the exhaust of gas or other ionized particles. The separation of the resulting gas or ionized particles further limits the size of secondary arc or are restrikes along a back portion of the pyrotechnic circuit interrupter.

Still further, in other aspects, the separation of the resulting gases can be directed away from a top surface of the arc chamber. In some scenarios, if the interrupter is triggered during an installation process, the resulting gases or discharge are directed away from the proximity of a human. This mitigates the potential for injury or harm caused by hot gas.

Technology disclosed herein can be applied to a variety of applications. Accordingly, although various benefits and combinations of aspects of the pyrotechnic circuit interrupter of the present application will be described, one skilled in the art will appreciate that various embodiments of the present application can include any single individual aspects or various combinations of aspects. Accordingly, reference to embodiments or alternative embodiments should not be construed as requiring any specific combination of aspects or otherwise limiting combination with other aspects unless specifically identified in the description.

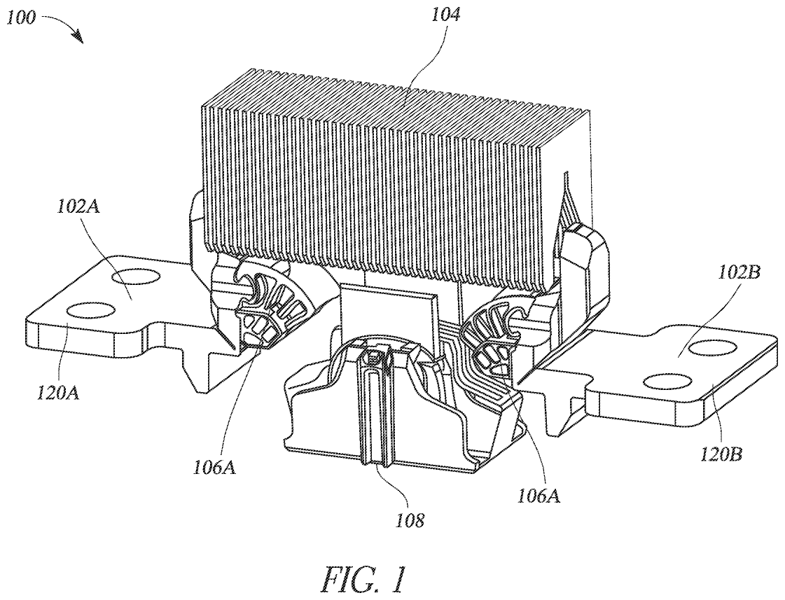

FIG. 1 depicts a side perspective of a pyrotechnic circuit interrupter 100 in accordance with illustrative embodiments of the present application. The pyrotechnic circuit interrupter 100 includes two portions of a busbar component 102A and 102B. The first busbar component 102A and the second busbar component 102B may be a single unitary busbar or may be separate connected busbar components. Illustratively, a busbar component can be made of a combination of materials including conductive materials for conducting electrical current and one or more insulating materials. The specific shape and material of the busbar components can vary based on the location of the busbar within an electric vehicle, the operating ranges of the cabling system and charging system, and the like.

The busbar components 102A and 102B may include an end portion 120A and 120B. The end portion 120A and 120B may include a plurality of mounting features for mounting the first busbar component 102A or the second busbar component 102B to additional components. The mounting features of the end portion 120A or 120B may include holes, slots, grooves, clamps, or other features. The end portion 120A or 120B may be connected to other busbar components. For example, a system may comprise a busbar with a portion missing and the pyrotechnic circuit interrupter may be integrated into the system.

The pyrotechnic circuit interrupter 100 further includes an arc chamber 104 for providing a primary arc path for the current between the two busbar components 102A and 102B. The pyrotechnic circuit interrupter 100 further includes mounting components 106A and 106B for receiving the busbar components 102A, 102B, respectively. The mounting components 106A, 106B are illustratively comprised of insulating materials, such as insulating plastics (e.g., nylon plastics, thermoplastics, thermoset materials, etc.) that prevent the formation of arcs through the mounting components 106A, 106B. FIG. 1 illustrates the mounting components 106A and 106B oriented in an upper position after a fault in which the busbar components 102A, 102B are no longer making direct contact.

The pyrotechnic circuit interrupter 100 further includes a pyrotechnic charge and pusher component 108 located in between the busbar components 102A, 102B and the arc chamber 104. As described herein, illustrative the pyrotechnic charge and pusher component 108 can be triggered upon detection of a fault to direct ionized particles or resulting gases toward the arc chamber. The portions of 106A, 106B and pusher component 108 are illustratively comprised of insulating materials, such as insulating plastics (e.g., nylon plastics, thermoplastics, thermoset materials, etc.) that prevent the formation of arcs in regions other than the arc chamber 104.

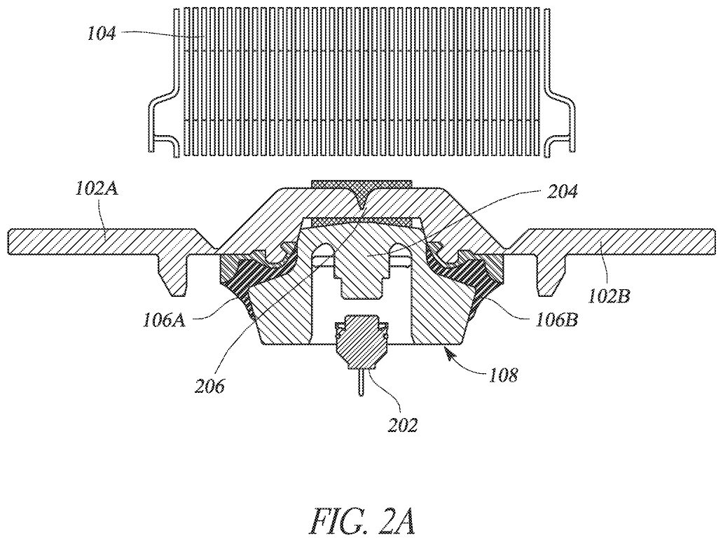

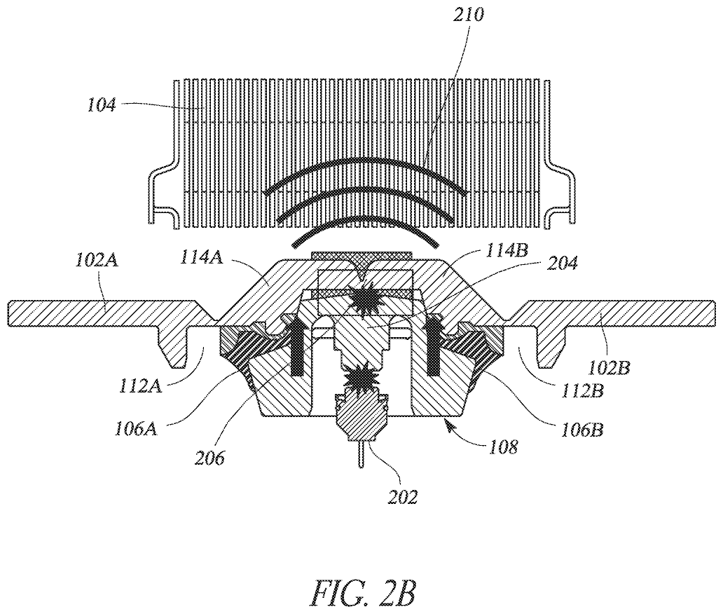

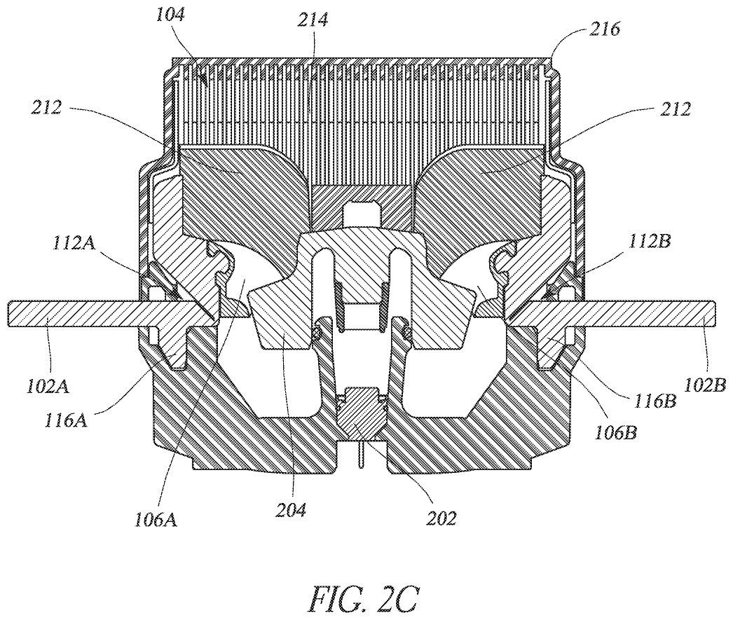

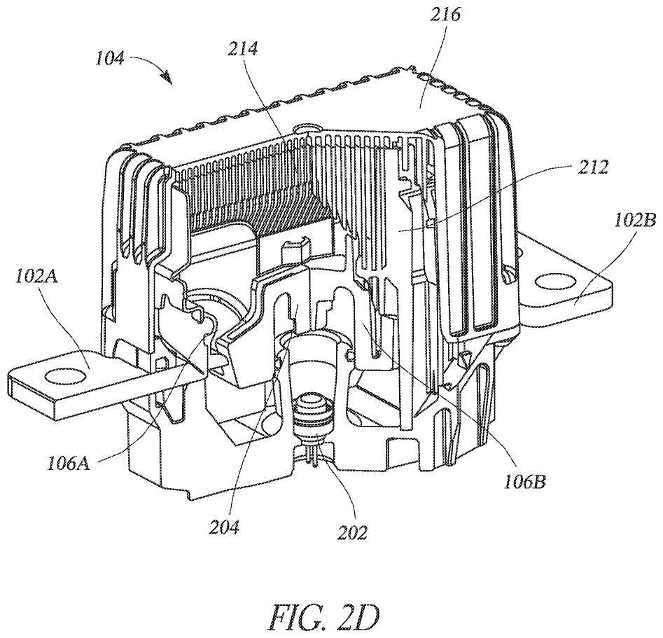

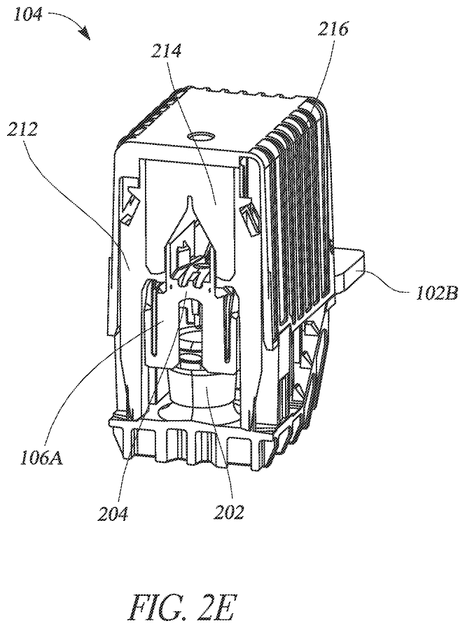

With reference to FIGS. 2A-2E, the operation of the illustrative components of FIG. 1 will be described. With reference first to FIG. 2A, in a first operational state, or nominal state, the busbar components 102A, 102B are physically connected and conducting electrical current. In this regard, no current flows in the arc chamber 104 and the mounting components 106A, 106B, and pyrotechnic charge and pusher component 108 do not mitigate any current flow. FIG. 2A illustrates that the pyrotechnic charge and pusher component 108 includes a pyrotechnic charge 202 adjacent to a pusher component 204 that forms the shaped shock wave as described herein. The specific shape of the pusher component 204 is illustrative in nature and should not be construed as limiting.

With reference to FIG. 2B, upon a trigger event related to a detected fault or other criteria, the pyrotechnic charge 202 is activated and created an upward force. This causes the fracturing of the busbar to separate busbar components 102A and 102B at location 206. Location 206 may include a weakening feature. The weakening feature may include a notch, a hole, a slot, a bend, a pre-bent area, or another suitable feature. The weakening feature may be configured to guide the fracture or separation of the first busbar component 102A from the second busbar component 102B. Additionally, the resulting shockwave 208 directs any resulting discharge (e.g., ionized materials) into the arc chamber. The first busbar component 102A may further comprise a bend location 112A and the second busbar component 102B may further comprise a bend location 112B. The bend location 112A and 112B may comprise a bend, slot, hole, pre-stressed area, pre-bent area, a notch, or another material weakening feature. The bend locations 112A and 112B may comprise a single feature or multiple features. The bend locations 112A and 112B may each be located a first distance 114A and 114B from location 206. The first distance 114A comprises a portion of the first busbar between the location 206 and the bend location 112A. Similarly, the first distance 114B comprises a portion of the second busbar between the location 206 and the bend location 112B.

Turning to FIG. 2C, after the triggering event, the pyrotechnic circuit interrupter 100 is in a second operating state in which typical current flow in the busbar is prevented and in which any potential resulting arcs are magnetically and physically directed to the arc chamber. As illustrated in FIG. 2C, the busbar components 102A, 102B are not in physical contact and include a portion that is substantially vertical. Additionally, at least some portion of the components 106A and 106B and the pyrotechnic pusher component 108, which are made of insulating materials prevent current flow or arc between the two busbar components. Additionally, as illustrated in FIG. 2C, the arc component 104 includes additional insulating materials 212 such that any resulting arcs are forced into the portion 214 of the arc component 104 by gas generated through evaporation of portions of the insulating material. FIGS. 2D and 2E illustrate different perspectives of the arc chamber 104 including a cross-section to depict the portion 214 and insulating materials 212. As illustrated in FIGS. 2D and 2E, the arc chamber can also have an external surface 216 that is non-conductive.

The outer surface 216 may comprise a housing that encompasses at least a portion of the arc chamber. The outer surface 216 may be made of a single part or may comprise multiple components. The outer surface 216 can include mounting or locating features. For example, the outer surface 216 may include a first mount 218A and a second mount 218B. The first busbar component 102A may include a first busbar mount 116A that connects with the first mount 218A to locate, hold, lock, or otherwise engage the first busbar component 102A with the housing 216. Similarly, the second busbar component 102B may include a first busbar mount 116A that connects with the first mount 218A to locate, hold, lock, or otherwise engage the first busbar component 102A with the housing 216.

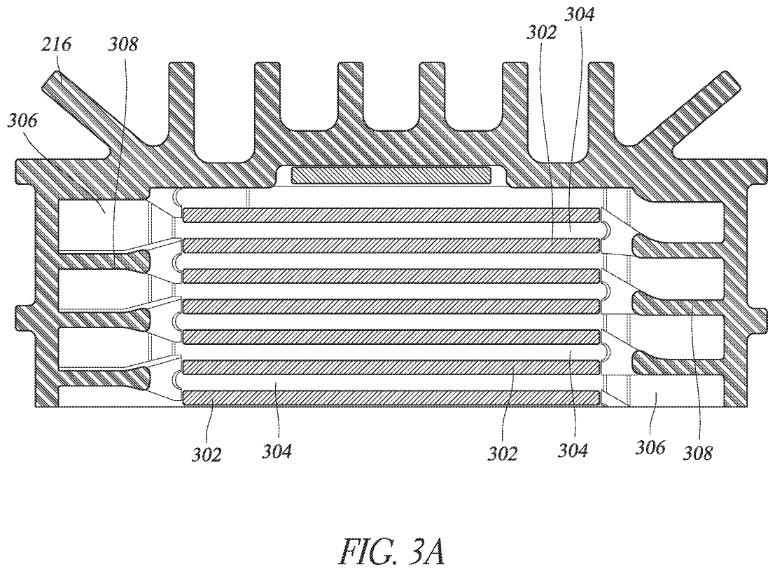

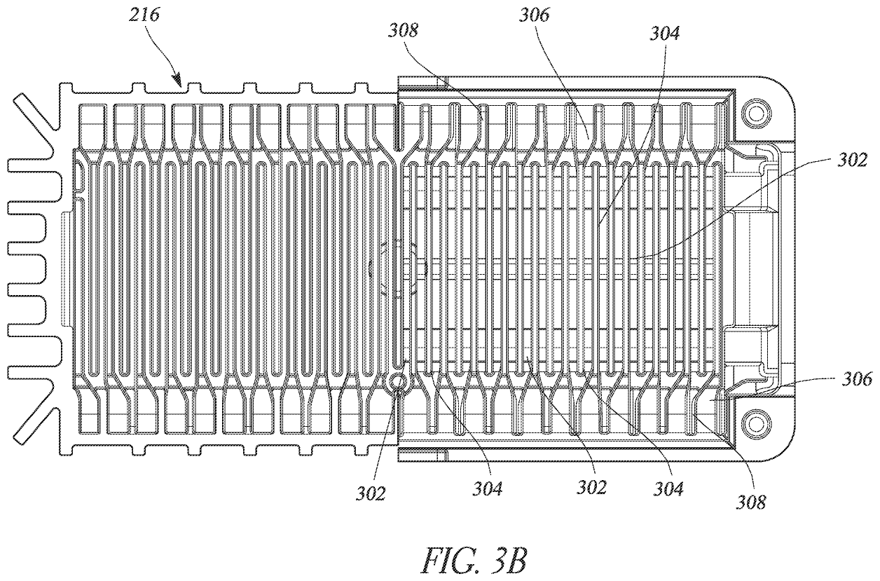

Turning now to FIG. 3A, in accordance with aspects of the present application, the arc chamber 104 of the pyrotechnic circuit interrupter can illustratively include interlocking or interdigitated insulating plates 302 or fins that separates out the exhaust of gas or other ionized particles. The separation of the resulting gas or ionized particles further reduces the likelihood of secondary are or arc restrikes along an exhaust portion of the pyrotechnic circuit interrupter. As illustrated in FIG. 3A, the plates 302 receive the ionized materials responsive to the shockwave created by the pyrotechnic charge and pusher component 108 and directed the resulting gas to a set of channels 304 to exhaust chambers 306. The exhaust chambers are formed such that barriers 308 exist in between each exhaust chamber 306. This interdigitates the resulting exhaust and prevents or mitigates secondary arcs forming between any two chambers 306. FIG. 3B illustrates a top perspective of the pyrotechnic circuit interrupter 100 with the plates 302, channels 304, chambers 306 and barriers 308.

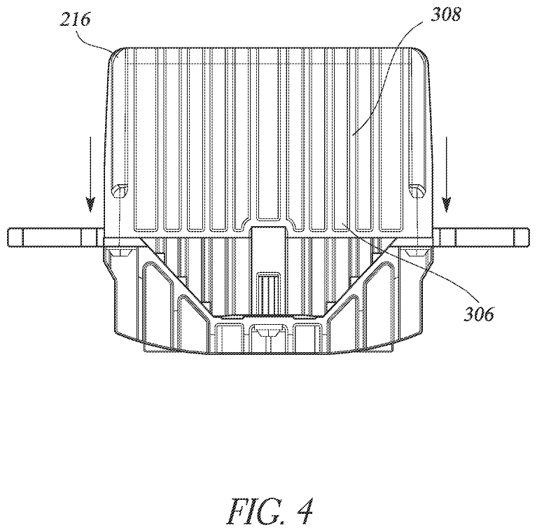

In accordance with yet other aspects of the present application, the chambers 306 and barriers 308 of the arc chamber can be further extended such that any resulting gases are directed in a downward direction, relative to the top surface of the pyrotechnic circuit interrupter 100. More specifically, the chambers 306 create a channel or path from the top surface as the ionized particles are directed upward and cause the set of digitized paths to be released from the arc chamber 104 in a downward direction. The downward direction is indicated by arrows in FIG. 4. The outer surface 216 can be constructed of an insulated material. In one embodiment, in the event the pyrotechnic charge 202 is activated during installation, any resulting gas materials (as described herein) are directed away from the user, including hands or tools that may be used during installation. This can prevent injury, such as significant burns.

Unless the context clearly requires otherwise, throughout the description and the claims, the words “comprise,” “comprising,” “include,” “including” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Where the context permits, words in the above Detailed Description using the singular or plural number may also include the plural or singular number respectively. The word “or” in reference to a list of two or more items, that word covers all of the following interpretations of the word: any of the items in the list, all of the items in the list, and any combination of the items in the list.

Moreover, conditional language used herein, such as, among others, “can,” “could,” “may,” “for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments.

The foregoing description has been described with reference to specific embodiments. However, the illustrative discussions above are not intended to be exhaustive or to limit the inventions to the precise forms described. Many modifications and variations are possible in view of the above teachings. Others skilled in the art are thereby enabled to best utilize the techniques and various embodiments with various modifications as suited to various uses.

Although the disclosure and examples have been described with reference to the accompanying drawings, various changes and modifications will become apparent to those skilled in the art. Such changes and modifications are to be understood as being included within the scope of the disclosure.

What is claimed is:

1. A circuit interrupter comprising:
a plurality of mounting components for receiving a first busbar and a second busbar component, wherein the plurality of mounting components are comprised of an insulating material;
an arc chamber for providing a primary arc path for a current between the first and second busbar components; and
a pyrotechnic charge and pusher component located in between the first and second busbar components and the arc chamber, wherein the pusher component can be triggered upon detection of a fault to direct ionized particles or resulting gases toward the arc chamber and wherein the pusher component is comprised of an insulating material.

2. The circuit interrupter of claim 1, wherein the circuit interrupter is associated with a first operating state in which current flow occurs between a unitary busbar component, the unitary busbar component including the first and second busbar components.

3. The circuit interrupter of claim 2, wherein the pyrotechnic charge is configured to fracture the unitary busbar component to form the first and second busbar components.

4. The circuit interrupter of claim 1, wherein the pusher is configured to bend the first busbar component and the second busbar components.

5. The circuit interrupter of claim 1, wherein the arc chamber comprises interlocking or interdigitated insulating plates configured to separate out discharge.

6. The circuit interrupter of claim 1, wherein the circuit interrupter is associated with second operating state in which typical current flow in the busbar is prevented and in which any potential resulting arcs are directed to the arc chamber.

7. A circuit interrupter comprising:
a pyrotechnic charge, wherein the pyrotechnic charge is configured to trigger upon detection of a fault, the triggering of the pyrotechnical charge generating a force; causing the circuit interrupter to enter a second operational state;
an arc chamber, wherein the force directs any discharge associated with the trigger of the pyrotechnic charge into the arc chamber; and
a pusher, wherein the force causes the pusher to move, and the pusher applies a contact force causing the circuit interrupter to transition from a first operational state to a second operational state.

8. The circuit interrupter of claim 7, wherein an associated unitary busbar component comprises a weakening feature.

9. The circuit interrupter of claim 7, wherein the arc chamber comprises interlocking or interdigitated insulating plates configured to separate out discharge.

10. The circuit interrupter of claim 7, wherein the arc chamber further comprises a plurality of chambers, the plurality of chambers configured to receive the discharge when the pyrotechnic charge is triggered.

11. The circuit interrupter of claim 10, wherein the plurality of chamber are further configured to direct the direct the discharge in a downward direction.

12. The circuit interrupter of claim 10, wherein the plurality of chamber are isolated to prevent combination of exhaust.

13. The circuit interrupter of claim 7, wherein the force comprises a shockwave.

14. The circuit interrupter of claim 7, wherein in the second operation state any potential resulting arcs are directed to an arc chamber.

15. A circuit interrupter comprising:
a plurality of mounting components for receiving busbar components, wherein the plurality of mounting components are comprised of an insulating material;
an arc chamber for providing a primary arc path for a current between a first busbar component and a second busbar component; and
means for directing ionized particles or resulting gases toward the arc chamber upon detection of a fault.

16. The circuit interrupter of claim 15, wherein the means for directing ionized particles or resulting gases toward the arc chamber upon detection of a fault includes a pyrotechnic charge and pusher component located in between the first and second busbar components and the arc chamber.

17. The circuit interrupter of claim 15, wherein the arc chamber comprises interlocking or interdigitated insulating plates configured to separate out discharge.
